(19) United States
(12) Patent Application Publication
(10) Pub. No.: US 2007/0099065 A1
(43) Pub. Date: May 3, 2007

(54) Current collection in anode supported tubular fuel cells

(76) Inventors: Jolyon Rawson, Wrentham, MA (US); Michael Brown, Cambridge, MA (US); Neil Fernandes, Cambridge, MA (US); Norman F. Bessette, Middleboro, MA (US); Douglas S. Schmidt, Walpole, MA (US)

Correspondence Address: BROMBERG & SUNSTEIN LLP, 125 SUMMER STREET, BOSTON, MA, 02110-1618, US

(21) Appl. No.: 11/404,998

(22) Filed: Apr. 14, 2006

Related U.S. Application Data
(60) Provisional application No. 60/671,595, filed on Apr. 15, 2005.

(51) Int. Cl. H01M 4/86; H01M 8/12

(52) U.S. Cl. 429/40; 429/31; 429/44; 429/32

(57) ABSTRACT

In a tubular solid-oxide fuel cell, current is collected from an inner anode layer at one or more discrete points along the length of the fuel cell that are accessible from the outside of the fuel cell. Current can be collected from the anode layer at both ends of the fuel cell, once in the center of the fuel cell, or at any of a multitude of axial points along the length of the fuel cell.

### PRIORITY

This patent application claims priority from U.S. Provisional Patent Application No. 60/671,595 entitled CURRENT COLLECTION IN ANODE SUPPORTED TUBULAR FUEL CELLS, which was filed on Apr. 15, 2005 in the names of Jolyon Rawson, Michael Brown, Neil Fernandes, Norman F. Bessette, and Douglas S. Schmidt, and is hereby incorporated herein by reference in its entirety.

This invention was made with Government support under DE-FC26-03NT 41838 awarded by the U.S. Department of Energy. The Government has certain rights in this invention.

### FIELD OF THE INVENTION

The present invention relates generally to solid oxide fuel cells, and, more particularly, to tubular solid-oxide fuel cells having an inner anode layer and multiple anodic current collection points to improve efficiency of the fuel cell.

### BACKGROUND OF THE INVENTION

Tubular solid oxide fuel cells (SOFCs). represent a significant advantage over planar-type SOFCs due to enhanced gas collection capability, ease of manufacture, and strength of the tubular design. Anode supported tubular SOFCs possess additional advantages over cathode or electrolyte supported cells due to lower cost, greater strength, and more intimate relationship with the critical gas component: the fuel. With this capture of the fuel, they also inherently have the ability to perform on-cell reformation of fuels rather than require external reforming equipment.

FIG. 1 is a cross-sectional view of a typical anode-supported tubular SOFC 100 as known in the art. Generally speaking, an anode-supported tubular SOFC 100 has a hollow, tubular inner anode layer 102, an electrolyte layer 104 formed on a portion of the outside of the anode layer, and a cathode layer 106 formed on a portion of the electrode layer. A cathode current collector 108, such as a silver wire, may be disposed on the cathode. Current flows radially from the inside to the outside along the length of the tube.

As shown in FIG. 2, current collection in anode-supported tubular SOFCs typically involves an anodic connection 204 and a cathodic connection 202 located at one end of the tubular fuel cell. This arrangement allows mechanical ease of assembly, utilizing the gas distribution manifolds as current collection devices. However, this arrangement generally results in large losses, proportional to the length and thickness of the anode supported fuel cell.

One drawback of the current collection arrangement shown in FIG. 2 is that the current needs to travel along the entire length of the tube. This can result in major power losses. FIG. 3 shows a representation of current as a function of tube length for an anode-supported tubular SOFC having anodic and cathodic current collectors at one end of the fuel cell. It is therefore desirable to reduce or minimize these losses to enhance cell performance and lower fuel cell costs.

Siemens Westinghouse describes the use of a strip down the length of a cathode supported fuel cell, allowing current collection along the length, with only circumferential losses. With such a design, improved current collection is generally realized at the expense of a more complicated system design and greater variability in the packing of the tubular fuel cells.

### SUMMARY OF THE INVENTION

In accordance with one aspect of the invention there is provided a solid-oxide fuel cell comprising a tubular inner anode having an inside and an outside; at least one tubular electrolyte segment formed on the outside of the anode; a tubular cathode segment formed on an outside of each electrolyte segment; and at least one discrete anodic current collector formed on the outside of the anode and accessible from outside of the fuel cell. The at least one discrete anodic current collector operates to reduce the effective operational length of the fuel cell.

In various alternative embodiments, each discrete anodic current collector may form a complete ring around the anode to maintain structural integrity. The anodic current collectors may be ceramic (e.g., LaCrO₃ or other suitable dual atmosphere ceramic) or metallic (e.g., nickel or other suitable dual atmosphere metal).

In additional embodiments, the at least one discrete anodic current collector may include an anodic current collector positioned at a proximal end of the fuel cell and an anodic current collector positioned at a distal end of the fuel cell. A wire may be coupled to the anodic current collector positioned at the distal end of the fuel cell and run through the inside of the anode to the proximal end. The at least one. discrete anodic current collector may further include at least one additional anodic current collector positioned between the proximal and distal ends, for example, substantially at a mid-point of the fuel cell.

In further embodiments, the at least one discrete anodic current collector may include an anodic current collector positioned along the length of the anode away from the ends, for example, substantially at a mid-point of the fuel cell. The at least one discrete anodic current collector may additionally or alternatively include a plurality of anodic current collectors positioned along the length of the fuel cell, for example, an anodic current collector positioned substantially at a mid-point of the fuel cell and additional anodic current collectors positioned proportionally from each end of the fuel cell.

In still further embodiments, the fuel cell may include at least one cathodic current collector adjacent to each anodic current collector. For example, the fuel cell may include two electrolyte segments and corresponding cathode segments separated by an anodic current collector, in which case the at least one cathodic current collector may include a cathodic current collector associated with each of the cathode segments.

In still further embodiments, the fuel cell may include an end cap coupled to one end of the tubular inner anode and couplable to a tubular inner anode of another such fuel cell, wherein the end cap is operably as an anodic current collector for both fuel cells. Thus, a larger fuel cell may be constructed from multiple fuel cells interconnected via the end cap. Each fuel cell may have an end cap, in which case the end caps may be connected so as to form the larger fuel cell. The end cap(s) typically allow fuel to flow between the fuel cells.

### BRIEF DESCRIPTION OF THE DRAWINGS

The foregoing and advantages of the invention will be appreciated more fully from the following further description thereof with reference to the accompanying drawings wherein:

FIG. 1 is a cross-sectional view of a typical anode-supported tubular SOFC as known in the art;

FIG. 2 shows a representation of a standard anode-supported tubular solid oxide fuel cell having anodic and cathodic current collectors at one end of the fuel cell as known in the art;

FIG. 3 shows a representation of current as a function of tube length for an anode-supported tubular SOFC having anodic and cathodic current collectors at one end of the fuel cell, as shown in FIG. 2;

FIG. 4 shows a representation of an anode-supported tubular solid oxide fuel cell with current collectors at both ends, in accordance with an embodiment of the present invention;

FIG. 5 shows a representation of an anode-supported tubular solid oxide fuel cell with a single center current collector, in accordance with an embodiment of the present invention;

FIG. 6 shows a representation of an anode-supported tubular solid oxide fuel cell with current collectors at the center and at both ends, in accordance with an embodiment of the present invention;

FIG. 7 is a cross-sectional view of an exemplary anode-supported tubular SOFC having anode current collectors at the middle and at both ends of the fuel cell in accordance with an embodiment of the present invention;

FIG. 8 is a cross-sectional view of electrical interconnections between adjacent fuel cells of the type shown in FIG. 7, in accordance with an embodiment of the present invention;

FIG. 9 shows a representation of an anode-supported tubular solid oxide fuel cell with current collectors positioned at various points along the length of the fuel cell, in accordance with an embodiment of the present invention; and

FIG. 10 shows an exemplary fuel cell with a wire run from the far end cap through the inside of the tube to the near end of the tube in accordance with an embodiment of the present invention.

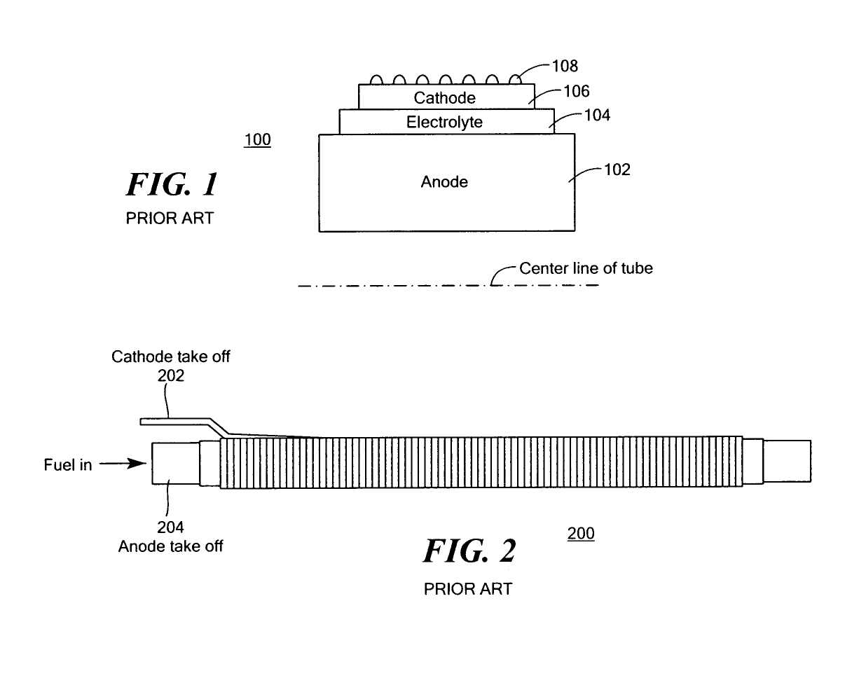

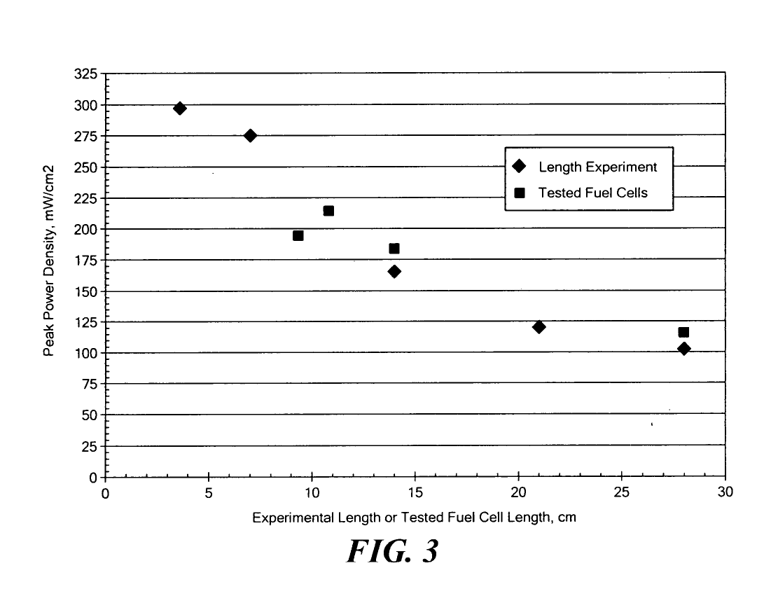

### DETAILED DESCRIPTION OF SPECIFIC EMBODIMENTS

In embodiments of the present invention, current is collected from the inner anode layer of a tubular solid-oxide fuel cell (SOFC) at one or more discrete points along the length of the fuel cell rather than at a single end of the fuel cell or using a strip down the entire length of the fuel cell. For example, current can be collected from the anode layer at both ends of the fuel cell, once in the center of the fuel cell, or at any of a multitude of axial points along the length of the fuel cell. Such discrete current collection points generally reduce the effective operational length of each section, eliminate circumferential losses for cells of any diameter, and allow for a simplified current collection arrangement. The system can be easily arranged in multiple geometries, with exceptional thermal cycling robustness and ease of connection due to the use of the entire circumference in the tubular geometry (rather than a strip along one side, minimizing stress buildup by maximizing strength) and the discrete placement of the connections along the length. Generally speaking, the more current collection points per given length of fuel cell, the higher the peak power of that fuel cell under any given circumstance. This can result in substantial gains in overall system performance and significant reduction of fuel cell costs. Increasing the length of the fuel cell and adding additional current collection points along the length allow the fuel cell to be as long as desired without the penalty of increased resistances, equating to an increase in power directly proportional to the length of the fuel cell.

The anode current collectors can be manufactured in a variety of ways, including, but in no way limited to, use of multiple metallic joints at either end of the tubular cell, use of a ceramic connection at either end of the cell, use of metallic connections at some or multiple points along the cell length, and use of ceramic connection at some or multiple points along the cell length.

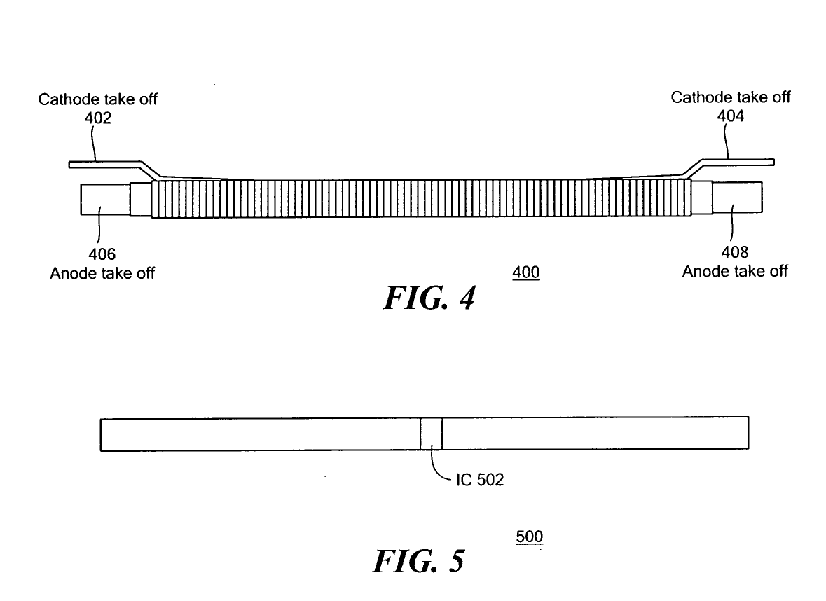

FIG. 4 shows an exemplary embodiment in which the SOFC includes anode and cathode current collectors at both ends of the SOFC. Specifically, the SOFC 400 includes a cathode current collector 402 and an anode current collector 406 at one end of the SOFC and includes a cathode current collector 404 and an anode current collector 408 at the other end of the SOFC. The anode current collectors 406 and 408 can be ceramic or metallic.

An exemplary ceramic current collector for an end of the SOFC can be made from an appropriately conductive material, such as LaCrO3, pressed into a form such that it forms a cap around the end of the tubular cell. It can then be simultaneously electrically connected and sealed by melting a metal (Au, Ag, Cu, Pt, Pd, Ni, Co, Zn are among the metals that could be used) brazing operation, or might be sintered together with one of these same metals, or a ceramic bond utilizing, among other materials, Fe, Si, Al, La, Cr, or Mn. This connection could also be formed by a ceramic-ceramic sinter bond. A ceramic or metallic lead (e.g., Ag) can be connected to the end cap, and current passed through it.

An exemplary metallic current collector for an end of the SOFC can be made by the brazing of a Ni cap to the end of the cell, and the insertion of an Ag pin, which allows an electrical connection from the external (air) side of the cell to the internal (fuel) side. Current can then be passed through the connection. On the other side of the cell, a Ni cup can be brazed to the cell. This cup acts as both a current collection device and a fuel distribution device.

FIG. 5 shows another exemplary embodiment of the present invention in which the SOFC includes a single centrally located anode current collector. Specifically, the SOFC 500 includes a single centrally located anode current collector 502. Such a centrally located anode current collector 502 tends to reduce the effective operational length of the SOFC by half. Again, the anode current collector 502 can ceramic or metallic.

For a metallic current collector, two caps can be brazed onto two separate cells. The two cells can then be joined by a metallic connector into which both cells are screwed. This connector allows gas to flow between cells, while providing a connection between the two cells. An Ag pin can be attached to the connector to allow for anodic current collection. Pins could also be formed of any appropriate ceramic, metal, or otherwise conductive materials that would survive in oxidizing or reducing atmospheres.

For a ceramic current collector, an appropriate dual-atmosphere ceramic, such as LaCrO3, can be formed into a ring around the cell at the mid-length point. An Ag connection can be made to the ceramic as the anodic current collection point.

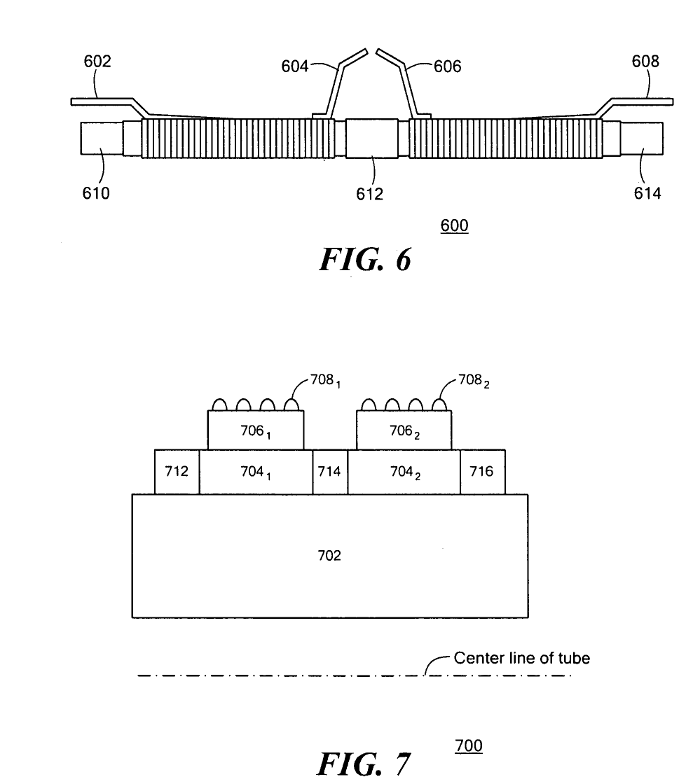

FIG. 6 shows another exemplary embodiment in which the SOFC includes anode current collectors at the middle and at both ends. Specifically, the SOFC 600 includes anode current collector 610 at one end, anode current collector 612 in the middle, and anode current collector 614 at the other end. The anode current collectors could be made as described above.

As shown in FIG. 6, when a current collector is located at a point along the length of the fuel cell away from the ends, there can be two cathode current collectors associated with a single anode current collector, with one on each side of the anode current collector. Specifically, in addition to cathode current collectors 602 and 608 situated at the ends of the SOFC, the SOFC includes two cathode current collectors 604 and 606, one on each side of center anode current collector 612.

FIG. 7 is a cross-sectional view of an exemplary tubular SOFC 700 having anode current collectors at the middle and at both ends of the fuel cell in accordance with an embodiment of the present invention. Specifically, the tubular SOFC 700 has a hollow, tubular inner anode layer 702 on which is formed two electrolyte/cathode/wire structures 704₁/706₁/708₁ and 704₂/706₂/708₂ separated by a central anode current collector 714, and also includes additional anode current collectors 712 and 716 at the ends of the SOFC.

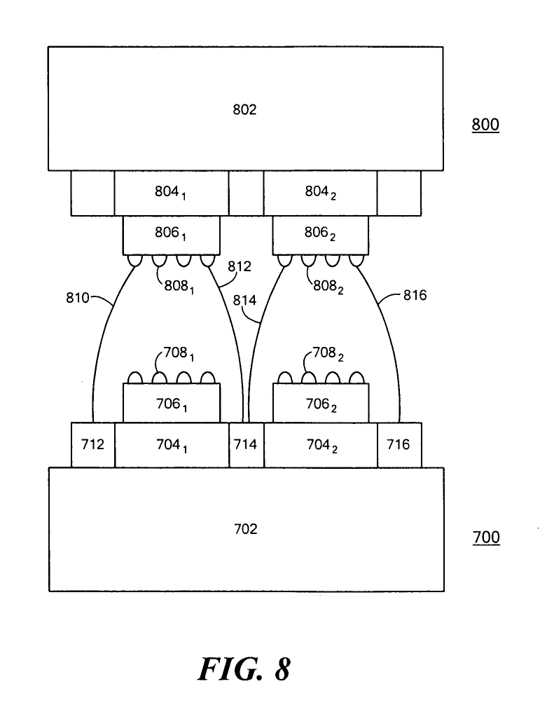

FIG. 8 is a cross-sectional view of electrical interconnections between adjacent fuel cells of the type shown in FIG. 7, in accordance with an embodiment of the present invention. Specifically, an adjacent tubular SOFC 800 has a hollow, tubular inner anode layer 802 on which is formed two electrolyte/cathode/wire structures 804₁/806₁/808₁ and 8042/806₂/808₂ separated by a central anode current collector 814, and also includes additional anode current collectors 812 and 816 at the ends of the SOFC. The anode current collector 712 is coupled to cathode current collector 808₁ via wire 810. The anode current collector 714 is coupled to cathode current collector 808₁ via wire 812 and to cathode current collector 808₂ via wire 814. The anode current collector 716 is coupled to cathode current collector 808₂ via wire 816. These electrical connections can be formed by leaving extended wire “tails” on the cathode current collectors 808¹ and 808₂ for subsequent bonding to the anode current collectors 712, 714, and 716.

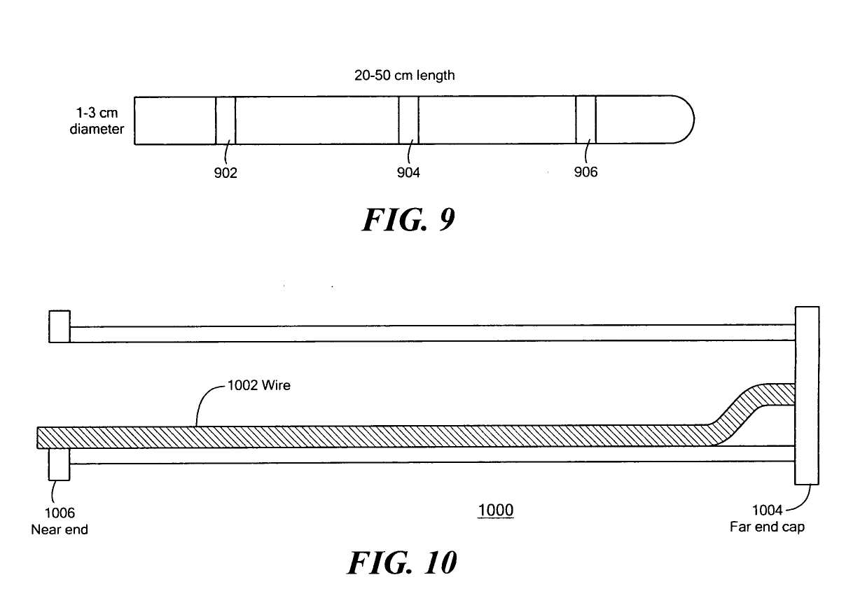

FIG. 9 shows another exemplary embodiment in which the SOFC includes multiple anode current collectors along the length of the fuel cell. In this example, the SOFC 900 is approximately 20-50 centimeters (e.g., 42 centimeters) in length and 1-3 centimeters (e.g., 2.2 centimeters) in diameter and can be closed at one end. One anode current collector 904 is positioned substantially at the midpoint of the fuel cell, while two other current collectors 902 and 906 are positioned proportionally from each end of the fuel cell.

In accordance with embodiments of the present invention, a SOFC could be made to whatever length is desired, with any diameter desired, and the effective cell length could be maintained constant. This significant result allows the formation of cells of any size dictated by other parameters (e.g., cost, packing density, ease of manufacture) without impact on the power that the cell can produce while minimizing the necessary fuel “manifolding.” When lengthening the cell or increasing the cell diameter, one or more connections generally need to be made as appropriate for the design.

Thus, the present invention may be embodied as a tubular SOFC having an inner anode and at least one anode current collector positioned so as to reduce the effective operational length of the fuel cell. Embodiments preferably minimize circumferential and axial losses while providing significant power improvement and potentially cost savings.

Embodiments may include a single anode current collector located away from the ends of the fuel cell (e.g., substantially at a midpoint of the fuel cell), anode current collectors at both ends of the fuel cell, anode current collectors at multiple points along the length of the fuel cell, or a combination of these. Current collectors may be ceramic or metallic. Ceramic current collectors may be formed from LaCrO3 or other suitable dual atmosphere ceramic and may be formed by plasma spray methods, vacuum infiltration, or sintering. Metal current collectors may be formed from Ni or other suitable dual atmosphere metal.

A single fuel cell may be fabricated from multiple fuel cell segments coupled together by an anode current collector. For example, two caps can be brazed onto two separate cells. The two cells can then be joined by a metallic connector into which both cells are screwed. This connector allows gas to flow between cells, while providing a connection between the two cells. An Ag pin can be attached to the connector to allow for anodic current collection. Pins could also be formed of any appropriate ceramic, metal, or otherwise conductive materials that would survive in oxidizing or reducing atmospheres.

The present invention may also be embodied as a tubular SOFC having an inner anode layer, an electrolyte layer, a cathode layer, and anode current collectors positioned at both ends of the fuel cell, for example, as shown in FIG. 4. Such an embodiment typically includes cathode current collectors at both ends of the fuel cell.

The present invention may also be embodied as a tubular SOFC having an inner anode layer, an electrolyte layer, a cathode layer, at least one anode current collector formed around the anode at a point along the length of the anode away from the ends, for example, as shown in FIG. 5, FIG. 6, and FIG. 9. Multiple anode current collectors can be placed at different points along the length of the fuel cell. Such embodiments typically include at least one cathode current collector adjacent to each anode current collector, although cathode current collectors may be positioned on both sides of an anode current collector, as shown in FIG. 6. The anode current collector(s) may be ceramic or metallic.

The present invention may also be embodied as a method for fabricating a tubular SOFC involving forming or attaching anode current collectors at both ends of a fuel cell having an inner anode. The anode current collectors may be ceramic or metallic.

The present invention may also be embodied as a method for fabricating a tubular SOFC involving forming at least one anode current collector around an inner fuel cell anode. Multiple anode current collectors can be placed at different points along the length of the fuel cell. One or more cathode current collectors may be positioned adjacent to each anode current collector. The anode current collector(s) may be ceramic or metallic.

Prototype fuel cells were tested with some of the variations described above. All cells were tested at 800 degrees Celsius, 75% fuel utilization on a 3%H20/H2 gas mixture with six times the required air. Cells were maintained at these conditions as power was peaked, and that value recorded. It was found that the prototypes generally had significantly improved performance over current SOFCs that use a current collector at one end only. It was also found that the use of the ceramic or metallic connection components had no significant effect on performance. The following table summarizes the relative performance of the experimental cells:

| | Relative | |
|---|---|---|
| | specific peak | Number |
| | power | of cells |
| Cell Type | performance | tested |
| Present state-of-the-art fuel cell | 1.00 | 32 |
| with current collector at one end | (basis) | |
| Ceramic end current collection set | 1.05 | 1 |
| up to mimic present state-of-the-art | | |
| (one end) | | |
| Metallic takeoffs from two ends | 1.60 | 4 |
| (e.g., FIG. 4) | | |
| Single metallic center current | 1.79 | 2 |
| collector (e.g., FIG. 5) | | |
| Single ceramic center current | 1.86 | 2 |
| collector (e.g., FIG. 5) | | |
| Triple ceramic current collectors | 2.50 | 15 |
| (e.g., FIG. 9) | | |

In order to collect current from an anode current collector, an external connector (e.g., silver) may be attached to the current collector. For example, in an SOFC having anode current collectors at both ends of the SOFC as shown in FIG. 4, an external connector may be attached to an end cap on the far end of the fuel cell (the near end may be connected directly to a manifold without a cap and external connector. Such external connectors may be prone to corrosion or damage, for example, due to permeation of hydrogen and oxygen. Specifically, hydrogen can flow through the silver and combine with oxygen outside the fuel cell to corrode the connector.

Thus, in one alternative embodiment, a wire is run from the far end cap through the inside of the tube to the near end of the tube, for example, for coupling with a near end cap or manifold. FIG. 10 shows a cross-sectional view an exemplary fuel cell 1000 with a wire 1002 running from the far end cap 1004 through the inside of the tube to the near end 1006 of the tube in accordance with an embodiment of the present invention.

Thus, the present invention may be embodied as a tubular SOFC having an inner anode with an anode current collector positioned at one end of the fuel cell and a wire electrically coupled to the anode current collector and passing through the interior of the fuel cell to the other end of the fuel cell. The wire may be coupled to an end cap that is attached to the anode current collector.

The present invention is not limited to the embodiments described herein or by the performance information disclosed herein. For example, one or more discrete anodic current collectors can be used in solid-oxide fuel cells having an inner anode generally in order to reduce the effective operational length of the fuel cell.

The present invention may be embodied in other specific forms without departing from the true scope of the invention. The described embodiments are to be considered in all respects only as illustrative and not restrictive.

What is claimed is:

1. A solid-oxide fuel cell comprising:
a tubular inner anode having an inside and an outside;
at least one tubular electrolyte segment formed on the outside of the anode;
a tubular cathode segment formed on an outside of each electrolyte segment; and
at least one discrete anodic current collector formed on the outside of the anode and accessible from outside of the fuel cell, the at least one discrete anodic current collector operating to reduce the effective operational length of the fuel cell.

2. A solid-oxide fuel cell according to claim 1, wherein each discrete anodic current collector forms a complete ring around the anode.

3. A solid-oxide fuel cell according to claim 1, wherein each discrete anodic current collector is ceramic.

4. A solid-oxide fuel cell according to claim 3, wherein the ceramic is LaCrO₃ or other suitable dual atmosphere ceramic.

5. A solid-oxide fuel cell according to claim 1, wherein each discrete anodic current collector is metallic.

6. A solid-oxide fuel cell according to claim 5, wherein the metal is nickel or other suitable dual atmosphere metal.

7. A solid-oxide fuel cell according to claim 1, wherein the at least one discrete anodic current collector includes an anodic current collector positioned at a proximal end of the fuel cell and an anodic current collector positioned at a distal end of the fuel cell.

8. A solid-oxide fuel cell according to claim 7, further comprising a wire coupled to the anodic current collector positioned at the distal end of the fuel cell and running through the inside of the anode to the proximal end.

9. A solid-oxide fuel cell according to claim 7, wherein the at least one discrete anodic current collector further includes at least one additional anodic current collector positioned between the proximal and distal ends.

10. A solid-oxide fuel cell according to claim 9, wherein the at least one additional anodic current collector includes an anodic current collector positioned substantially at a mid-point of the fuel cell.

11. A solid-oxide fuel cell according to claim 1, wherein the at least one discrete anodic current collector includes an anodic current collector positioned along the length of the anode away from the ends.

12. A solid-oxide fuel cell according to claim 11, wherein the at least one discrete anodic current collector includes an anodic current collector positioned substantially at a mid-point of the fuel cell.

13. A solid-oxide fuel cell according to claim 1, wherein the at least one discrete anodic current collector includes a plurality of anodic current collectors positioned along the length of the fuel cell.

14. A solid-oxide fuel cell according to claim 13, wherein the plurality of anodic current collectors includes an anodic current collector positioned substantially at a mid-point of the fuel cell and additional anodic current collectors positioned proportionally from each end of the fuel cell.

15. A solid-oxide fuel cell according to claim 1, further comprising at least one cathodic current collector adjacent to each anodic current collector.

16. A solid-oxide fuel cell according to claim 15, wherein the fuel cell includes two electrolyte segments and corresponding cathode segments separated by an anodic current collector, and wherein the at least one cathodic current collector includes a cathodic current collector associated with each of the cathode segments.

17. A solid-oxide fuel cell according to claim 1, further comprising an end cap coupled to one end of the tubular inner anode and couplable to a tubular inner anode of another such fuel cell, wherein the end cap is operably as an anodic current collector for both fuel cells.

18. A solid-oxide fuel cell according to claim 17, further comprising said other fuel cell coupled via the end cap.

19. A solid-oxide fuel cell according to claim 18, wherein said other fuel cell includes an end cap coupled to one end of its respective tubular inner anode, and wherein the two end caps are coupled to one another so as to join the two fuel cells.

20. A solid-oxide fuel cell according to claim 17, wherein the end cap allows gas to flow between the two fuel cells.
